(19) United States
(12) Patent Application Publication
(10) Pub. No.: US 2026/0179341 A1
(43) Pub. Date: Jun. 25, 2026

(54) METHOD FOR GENERATING A THREE-DIMENSIONAL SCENE, COMPUTER PROGRAM AND DEVICE THEREFOR

(71) Applicant: BULL SAS, LES-CLAYES-SOUS-BOIS (FR)

(72) Inventors: Nicolas ARNAISE, Bourgoin-Jallieu (FR); Louis DEVEZE, Fontaine (FR); Anaïs DRUART, Grenoble (FR)

(73) Assignee: BULL SAS, LES-CLAYES-SOUS-BOIS (FR)

(21) Appl. No.: 19/382,862

(22) Filed: Nov. 7, 2025

(30) Foreign Application Priority Data
Dec. 19, 2024 (EP) 24307206.3

(51) Int. Cl. G06T 19/20

(52) U.S. Cl. CPC G06T 19/20; G06T 2219/2004; G06T 2219/2016

(57) ABSTRACT

The invention relates to a method (20) for generating a three-dimensional scene, comprising the steps:
for each of at least one previously selected 3D object:
   placing (26) said 3D object in a three-dimensional reference frame, said 3D object being aligned with an active support surface of the three-dimensional scene, each active support surface being a support surface orthogonal to a director vector of an altitude axis of the virtual three-dimensional reference frame, to within a predetermined angular tolerance;
   updating an occupancy map of active support surfaces;
for each collision detected between 3D objects in the virtual three-dimensional reference frame, implementing a correction (28) comprising a movement of at least one 3D object affected by said collision based on the occupancy map.

This application claims priority to European Patent Application Number 24307206.3, filed 19 Dec. 2024, the specification of which is hereby incorporated herein by reference.

### BACKGROUND OF THE INVENTION

### Field of the Invention

At least one embodiment of the invention relates to a method for generating a three-dimensional scene.

At least one embodiment of the invention also relates to a computer program and a device implementing such a method.

At least one embodiment of the invention applies to the field of computer science, and more specifically to the automated generation of three-dimensional scenes.

### DESCRIPTION OF THE RELATED ART

Three-dimensional scenes are known to be generated, for example to create synthetic images for training artificial intelligence models, notably computer vision models.

During such generation, in order to obtain a realistic scene, it is imperative that the three-dimensional objects (or “3D objects”) present in the scene are positioned coherently therebetween, without collision, that is, without interpenetrating.

Conventionally, to achieve such an objective, an operator imports the desired 3D objects into a design software and manually positions them, avoiding collisions between 3D objects, while orienting said objects in various ways to increase the realism of the three-dimensional scene created.

Nevertheless, such a method is not entirely satisfactory.

Indeed, the manual placement of 3D objects is extremely time-consuming, requires a great deal of precision and skill on the part of the operator, and is conducive to the occurrence of numerous errors and approximations.

One object of at least one embodiment of the invention is to overcome at least one of the drawbacks of the prior art.

Another aim of at least one embodiment of the invention is to provide an automated method for generating a three-dimensional scene that offers a realistic rendering while avoiding collisions between 3D objects.

### BRIEF SUMMARY OF THE INVENTION

To this end, one or more embodiments of the invention relates to a method of the aforementioned type, the method being implemented by computer and comprising the steps of:
based on a generation instruction comprising, for at least one predetermined 3D object type, a corresponding number of instances, selecting, in a 3D object bank, a number of 3D objects for each 3D object type, equal to the number of instances, the bank of 3D objects comprising, for each predetermined 3D object type, at least one corresponding 3D object, and, for each 3D object:
   at least one orientation vector indicative of a corresponding admissible orientation; and
   for each orientation vector, a corresponding support surface, indicative of an upper surface of the 3D object when said 3D object is oriented along said orientation vector;
for each 3D object selected in the 3D object bank:
   placing said 3D object in a predetermined virtual three-dimensional reference frame, said 3D object being aligned with an active support surface of the three-dimensional scene, each active support surface being a support surface orthogonal to a director vector of an altitude axis of the virtual three-dimensional reference frame, to within a predetermined angular tolerance;
   updating an occupancy map of active support surfaces;
for each collision detected between 3D objects in the virtual three-dimensional reference frame, implementing a correction comprising a movement of at least one 3D object affected by said collision based on the occupancy map.

Indeed, by virtue of the use of support surfaces, in particular of active support surfaces, the three-dimensional scene, although generated entirely automatically, presents a realistic appearance, avoiding the arrangement of 3D objects in a way that might seem unnatural or even implausible, and doing so in a way that is simple and generalizable to all the 3D objects created.

Additionally, the use of the occupancy map enables collisions to be resolved easily, by moving the 3D objects affected by said collisions onto active support surfaces capable of receiving said 3D objects.

Advantageously, the method according to at least one embodiment of the invention has one or more of the following features, taken in isolation or according to any technically possible combination:
for each current 3D object, the placement step comprises:
random selection of an orientation vector from the at least one corresponding orientation vector;
random selection of an active support surface;
orientation of the current 3D object according to the selected orientation vector, so that the selected orientation vector is orthogonal to the selected active support surface;
alignment of the current 3D object with the selected active support surface;
the placement step further comprises a random rotation of the current 3D object about the selected orientation vector;
after the current 3D object has been aligned, an axis directed by the director vector of the altitude axis of the virtual three-dimensional reference frame and passing through a center of gravity of the current 3D object intersects the selected active support surface;
the center of gravity of the current 3D object is a barycenter of vertices of a mesh of said 3D object;
for each collision detected, the correction step comprises, for at least one 3D object affected by the collision:
searching, based on the occupancy map, for an active support surface capable of receiving said 3D object without collision;
if an active support surface capable of receiving said 3D object without collision is found, aligning the 3D object with said active support surface found;
the method comprises, as long as no active support surface capable of receiving said 3D object without collision is found, iterative implementation of the steps:
orienting the 3D object according to another untested orientation vector of the 3D object;
searching, in the occupancy map, for an active support surface capable of receiving said 3D object without collision;
the method comprises deleting the 3D object if no active support surface capable of receiving said 3D object without collision is found;
the method comprises, in response to an instruction to replace a selected 3D object previously placed in the virtual three-dimensional reference frame, replacing the selected 3D object with a new 3D object of the same type, preferably at the same position in the virtual three-dimensional reference frame;
the method further comprises, in the event of a collision being detected following the replacement of the selected 3D object by the new 3D object, implementing the correction step to correct the detected collision;
the method comprises, in response to an instruction to lock a selected 3D object previously placed in the virtual three-dimensional reference frame, locking a position and an orientation of said selected 3D object in the virtual three-dimensional reference frame, and generating an instruction to lock the 3D object on which the selected 3D object is aligned.

According to at least one embodiment of the invention, a computer program is provided which comprises executable instructions, which, when they are executed by a computer, implement the steps of the method as defined above.

The computer program can be in any computer language, such as, for example, in machine language, in C, C++, JAVA, Python, etc.

According to at least one embodiment of the invention, a computing device for generating a three-dimensional scene is proposed, the computing device comprising a memory and a processing unit,
the memory being configured to store a bank of 3D objects comprising, for at least one predetermined 3D object type, at least one corresponding 3D object, and, for each 3D object:
   at least one orientation vector indicative of a corresponding admissible orientation; and
   for each orientation vector, a corresponding support surface, indicative of an upper surface of the 3D object when said 3D object is oriented along said orientation vector;
the processing unit being configured to:
   based on a generation instruction comprising, for at least one 3D object type, a corresponding number of instances, select, from the 3D object bank, for each 3D object type, a number of 3D objects equal to the number of instances;
   for each 3D object selected in the 3D object bank:
      placing said 3D object in a predetermined virtual three-dimensional reference frame, said 3D object being aligned with an active support surface of the three-dimensional scene, each active support surface being a support surface orthogonal to a director vector of an altitude axis of the virtual three-dimensional reference frame, to within a predetermined angular tolerance;
      updating an occupancy map of active support surfaces;
   for each collision detected between 3D objects in the virtual three-dimensional reference frame, implementing a correction comprising a movement of at least one 3D object affected by said collision based on the occupancy map.

The device according to one or more embodiments of the invention can be any type of apparatus such as a server, a computer, a tablet, a calculator, a processor, a computer chip, programmed to implement the method according to at least one embodiment of the invention, for example by running the computer program according to one or more embodiments the invention.

### BRIEF DESCRIPTION OF THE DRAWINGS

The one or more embodiments of the invention will be better understood from reading the following description, which is given solely by way of non-limiting example and with reference to the accompanying drawings. These show:

FIG. 1 is a schematic depiction of a computing device according to one or more embodiments of the invention;

FIG. 2 is a flowchart of a generation method implemented by the device of FIG. 1, according to one or more embodiments of the invention;

FIG. 3 is a flowchart detailing a placement step of the method of FIG. 2, according to one or more embodiments of the invention; and

FIG. 4 is a flowchart detailing a collision correction step of the method of FIG. 2, according to one or more embodiments of the invention.

### DETAILED DESCRIPTION OF THE INVENTION

It is clearly understood that the one or more embodiments that will be described hereafter are by no means limiting. In particular, it is possible to imagine variants of the one or more embodiments of the invention that comprise only a selection of the features disclosed hereinafter in isolation from the other features disclosed, if this selection of features is sufficient to confer a technical benefit or to differentiate the one or more embodiments of the invention with respect to the prior art. This selection comprises at least one preferably functional feature which is free of structural details, or only has a portion of the structural details if this portion alone is sufficient to confer a technical benefit or to differentiate the one or more embodiments of the invention with respect to the prior art.

In particular, all of the described variants and embodiments can be combined with each other if there is no technical obstacle to this combination.

In the figures and in the remainder of the description, the same reference has been used for the features that are common to a number of figures.

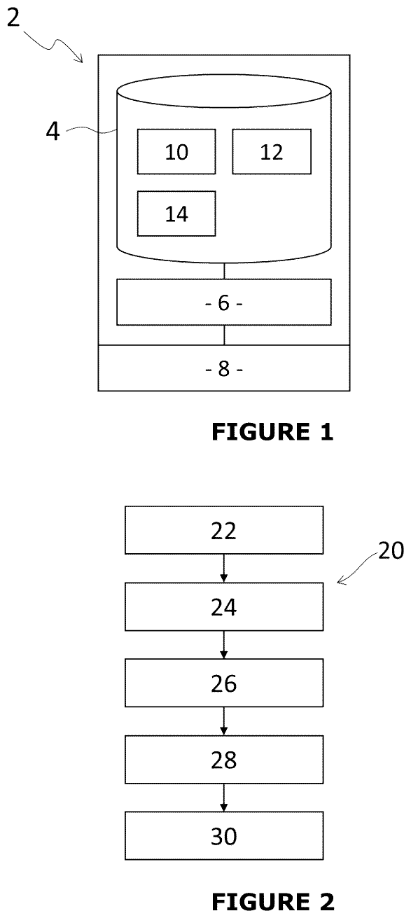

A computing device 2 according to one or more embodiments of the invention is shown in FIG. 1.

The computing device 2 is intended to automatically generate a three-dimensional scene (known as a “3D scene”) based on a generation instruction entered by a user.

The computing device 2 comprises a memory 4 and a processing unit 6 connected therebetween. Additionally, the computing device 2 comprises a user interface 8 for entering the generation instruction.

Preferably, in at least one embodiment, the computing device 2 further comprises a display medium 9 for displaying the generated 3D scene. In this case, the user interface 8 is advantageously configured to allow the user to interact with the generated 3D scene, and in particular with three-dimensional objects (or “3D objects”) in said 3D scene.

### Memory 4

The memory 4 is preferably configured to store 3D design software 10 (known as “design software”), intended for manipulating 3D objects in a 3D scene and/or generating synthetic images from a 3D scene modeled in said design software 10.

Additionally, the memory 4 is configured to store a bank 12 of 3D objects (known as the “object bank”).

The object bank 12 comprises a plurality of 3D objects, the appearance of each of which is determined by a respective three-dimensional mesh.

Additionally, in the object bank 12, each 3D object is associated with a corresponding type, descriptive of the object (that is, indicative of its appearance).

For example, a given 3D object belongs to the “table”, “chair”, “armchair”, “cup”, “plate”, “car” type, etc.

Preferably, each type belongs to a set of types, known as a “category”, grouping together types of a similar nature, so that each category comprises at least one type.

For example:
the “table”, “chair” and “armchair” types belong to the “furniture” category;
the “cup” and “plate” types belong to the “tableware” category; and
the “car” type belongs to the “vehicle” category.

Additionally, for each 3D object, the object bank 12 comprises at least one corresponding orientation vector. Each orientation vector is indicative of a corresponding permissible orientation of the 3D object. More precisely, for each 3D object placed in a given virtual three-dimensional reference frame, the admissible (that is, acceptable) orientations of said 3D object are those orientations in which a corresponding orientation vector is collinear with a director vector of the altitude axis (within a predetermined angular tolerance, for example ±5°) and oriented along the increasing altitudes.

Each admissible orientation represents a situation in which a real object identical to the 3D object would be stable, if it were positioned in said orientation on a horizontal surface (that is, orthogonal to the altitude axis) and if it were subjected to gravity. In this case, the orientation vector corresponding to said orientation is vertical (within the predetermined angular tolerance), and oriented along the increasing altitudes (that is, opposite to the gravity vector).

Additionally, for each 3D object, and for each orientation vector, the object bank 12 comprises at most one corresponding support surface. Such a support surface is indicative of an upper surface of the 3D object when said 3D object is oriented such that the respective orientation vector is collinear with a director vector of the altitude axis of a virtual three-dimensional reference frame and has the same direction as said director vector.

Each support surface is a surface that may or may not carry other 3D objects, depending on the current orientation of the corresponding 3D object.

Preferably, for each 3D object, the object bank 12 comprises a position of a respective center of gravity.

In particular, for each 3D object, the corresponding center of gravity is a barycenter of vertices of the mesh of said 3D object. In other words, a position, in a local reference frame linked to the 3D object, of the respective center of gravity is a weighted average of the positions of the vertices of the mesh.

For example, for each vertex, the corresponding weighting coefficient is equal to the sum of the lengths of the edges connected to said vertex, divided by the number of edges connected to said vertex, and by the average length of edges of the 3D object.

Even more preferably, for each 3D object, the object bank 12 comprises a respective bounding box.

Conventionally, such a bounding box is the smallest rectangular parallelepiped aligned with the local reference frame of the object (that is, each edge of the bounding box is parallel to an axis of the local reference frame), and containing all the vertices of the respective mesh.

Alternatively, the design software 10 is configured to calculate each bounding box and/or each center of gravity on the fly, when generating 3D objects.

Advantageously, for a given 3D scene, the memory 4 is additionally configured to store a corresponding occupancy map. Such an occupancy map is indicative, for each 3D object of said given 3D scene, for each corresponding active support surface, and at a given instant, of the parts of said support surface that are occupied by other 3D objects of the 3D scene.

For the purposes of one or more embodiments of the invention, “active support surface” means a support surface for which, in the current orientation of the associated 3D object, the respective orientation vector forms an angle with the director vector of the altitude axis (oriented along the increasing altitudes) that is less than or equal to the aforementioned predetermined angular tolerance. As a result, each active support surface is orthogonal to said director vector, within the predetermined angular tolerance.

The use of such an occupancy map is advantageous, as it avoids the creation of stacks of unstable objects, likely to detract from the final realism of the 3D scene.

Conversely, the inactive support surfaces are preferably not referenced in the occupancy map.

### Processing Unit 6

The processing unit 6 is configured to implement a method 20 for generating a 3D scene (known as the “generation method”) according to at least one embodiment of the invention, described with reference to FIG. 2, according to one or more embodiments of the invention.

As shown in this figure, the generation method 20 comprises a reception step 22, a selection step 24, a placement step 26 and a collision correction step 28 (known as the “correction step”).

Preferably, the generation method 20 further comprises a modification step 30, subsequent to the correction step 28.

The features of the processing unit 6 will become apparent from the following description of the generation method 20.

### Reception Step 22

The processing unit 6 is configured to wait for a user to enter a generation instruction during the reception step 22.

Such a generation instruction comprises at least one type of 3D object desired in the 3D scene, from the 3D object types included in the object bank 12.

Additionally, for each desired 3D object type, the instruction comprises a corresponding number of instances, noted M (non-zero positive integer), indicative of the number of 3D objects of said type that the user wishes to see present in the 3D scene.

In other words, each desired 3D object type i is associated with a corresponding number of instances Mᵢ, so that the sum of all Mᵢ is a positive non-zero integer.

Preferably, such a generation instruction also comprises dimensions of the 3D scene. In particular, such dimensions comprise coordinates indicative of the spatial boundaries of a virtual box in which all 3D objects in the 3D scene to be generated are to be arranged. In this case, the lowest altitude plane forms a floor.

Optionally, the generation instruction also comprises, for at least one face of the virtual box, an indication of a corresponding desired appearance (texture, pattern, etc.).

### Selection Step 24

Additionally, the processing unit 6 is configured in such a way that, during the selection step 24, it selects Mᵢ 3D objects from the object bank 12 for each desired 3D object type i entered by the user.

For example, for each desired 3D object type i, the processing unit 6 is configured to draw Mᵢ randomly from the 3D objects associated with said type in the object bank 12.

### Placement Step 26

Additionally, the processing unit 6 is configured to place each selected 3D object in a same predetermined virtual three-dimensional reference frame during the placement step 26.

Even more precisely, the processing unit 6 is configured to align each selected 3D object with an active support surface of another 3D object already existing in the virtual three-dimensional reference frame.

By “3D object A aligned with an active support surface of 3D object B”, it is understood, for the purposes of one or more embodiments of the invention, that 3D object A is positioned so that the lowest altitude vertices of its mesh belong to the active support surface of 3D object B, an orientation vector selected for 3D object A being orthogonal to the support surface of 3D object B.

Preferably, in the case where the generation instruction comprises the dimensions of the 3D scene, the processing unit 6 is configured to first generate, in the virtual three-dimensional reference frame, the virtual box delimiting the 3D scene. In this case, the processing unit 6 is configured to consider the floor of the virtual box (that is, its lowest altitude face) as an active support surface (the virtual box forming a 3D object).

Alternatively, the processing unit 6 is, by default, configured so that all 3D objects in the generated 3D scene are arranged in a bounding volume having predetermined coordinates. In this case, the processing unit 6 is advantageously configured to consider the lowest altitude plane of said bounding volume as an active support surface (the bounding volume forming a 3D object).

Additionally, the processing unit 6 is configured to update the occupancy map after each current 3D object has been placed.

More precisely, the processing unit 6 is configured so that, at the end of the placement step 26, each object is aligned with an active support surface of another 3D object present in the virtual three-dimensional reference frame.

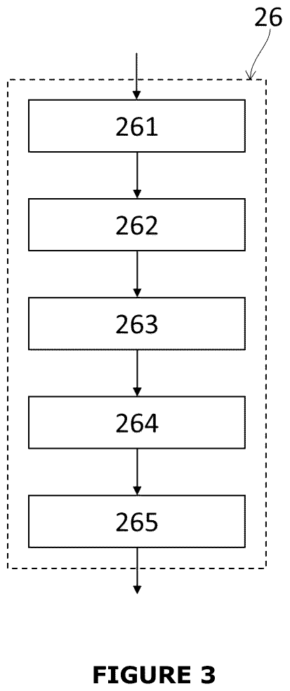

A preferred implementation of the placement step 26 is shown in FIG. 3, according to one or more embodiments of the invention.

As shown in this figure, to carry out such a placement, the processing unit 26 is configured so as to randomly select, for each selected 3D object, known as the “current 3D object”, during a phase 261, an orientation vector from the at least one orientation vector corresponding to said 3D object.

Additionally, the processing unit 6 is configured to randomly select, during a phase 262, an active support surface of the 3D scene (such as an active surface of another 3D object previously placed in the virtual three-dimensional reference frame, or else the floor of the virtual box or the lowest altitude plane of the bounding volume).

The processing unit 6 is also configured, in a phase 263, to orientate the current 3D object so that the corresponding selected orientation vector is orthogonal to the selected active support surface.

Additionally, the processing unit 6 is preferably configured to apply a random rotation about the selected orientation vector to the current 3D object during a phase 264.

Additionally, the processing unit 6 is configured, during a phase 265, to align the current 3D object with the selected active support surface, that is, to apply a translation to said 3D object so that the lowest altitude vertex or vertices of the corresponding mesh belong to the selected active support surface.

Advantageously, in this case, the processing unit 6 is configured so that, at the end of such a translation, an axis directed by the director vector of the altitude axis and passing through the center of gravity of the current 3D object intersects the selected support surface.

Such a feature is advantageous in that it prevents the generation of 3D scenes representing situations wherein one or more objects would have the majority of their “weight” in a vacuum.

### Correction Step 28

The processing unit 6 is also configured to detect possible collisions during the correction step 28.

For the purposes of one or more embodiments of the invention, “collision” is understood to mean a situation in which the meshes (or the bounding boxes) of two or more 3D objects in the virtual three-dimensional reference frame interpenetrate.

Additionally, the processing unit 6 is configured to correct the collisions detected.

In particular, the processing unit 6 is configured to move, for each collision detected, at least one 3D object affected by said collision, based on the occupancy map.

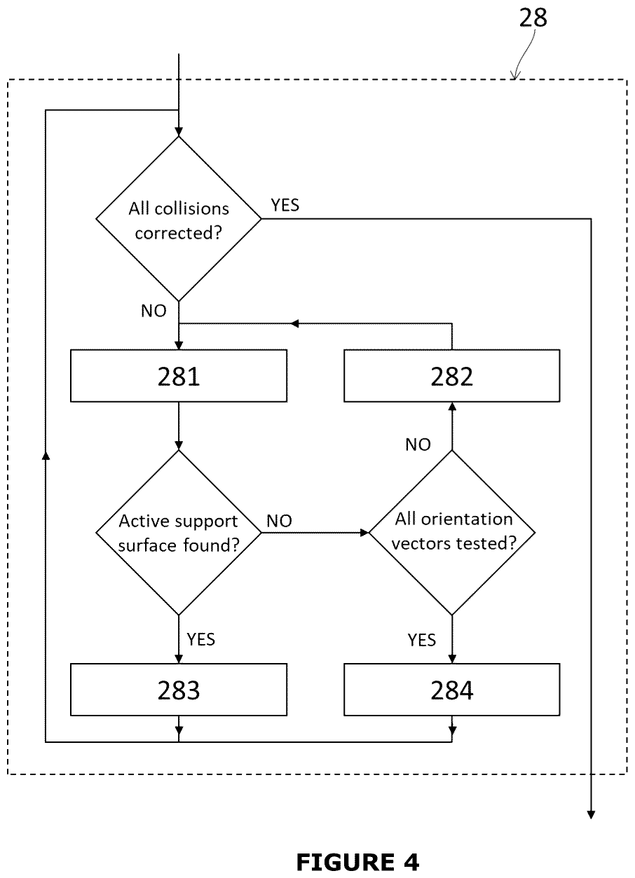

A preferred implementation of the correction step 28 is shown in FIG. 4, according to one or more embodiments of the invention.

As shown in this figure, in order to perform such a correction, the processing unit 6 is configured to implement a processing loop, repeated until all collisions in the 3D scene have been processed.

More precisely, the processing unit 6 is configured so that, during a phase 281, for at least one 3D object concerned by a collision, known as a “current collision”, it searches, based on the occupancy map, for an active support surface capable of receiving said 3D object (that is, an active support surface on which said 3D object is likely to be aligned) without collision.

More specifically, such a search is carried out on the unoccupied portions of active support surfaces, identified by means of the occupancy map.

For example, to carry out such a search, the processing unit is configured to implement an SDS algorithm (Stochastic Diffusion Search) to promote an active support surface search in the vicinity of the initial position of the 3D object.

Preferably, as long as no active support surface capable of receiving said 3D object is found, the processing unit 6 is configured to, during a phase 282, orient the 3D object according to another untested orientation vector of said object. In other words, the processing unit 6 is configured to orient the 3D object so that the new orientation vector is collinear with the director vector of the altitude axis, and in the same direction.

In this case, the processing unit 6 is configured to carry out another search, during a new phase 281, by means of the occupancy map, of an active support surface capable of receiving said 3D object oriented according to this new orientation vector.

Additionally, in the event that an active support surface capable of receiving the 3D object (without causing a collision) is found, the processing unit 6 is configured to align, during a phase 283, the 3D object with said active support surface found, and more precisely to align the 3D object with said support surface at a portion of the support surface such that a collision is not caused (for example, a portion having dimensions greater than a footprint of the 3D object on the respective support surface). In this case, the next collision detected is processed.

Furthermore, if no active support surface capable of receiving the 3D object is found (in particular, for all admissible orientations tested), the processing unit is configured to delete the 3D object, during a phase 284.

Preferably, in this case, the processing unit 6 is also configured to broadcast an alert indicative of such a deletion to the user.

Additionally, in this case, the next detected collision is processed.

### Modification Step 30

Preferably, during the modification step 30, the processing unit 6 is configured to control the display, on the display medium 9, of the 3D scene obtained after the correction step 28.

Even more preferably, the processing unit 6 is configured to allow the user to interact with the generated 3D scene, by means of the user interface 8.

Such an interaction comprises, for example, a movement, or else a replacement.

In particular, if the user's entry of an instruction to replace a 3D object in the displayed 3D scene is detected, the processing unit 6 is configured to replace the selected 3D object with a new 3D object of the same type, preferably maintaining the same position in the virtual three-dimensional reference frame.

In this case, the processing unit 6 is, preferably, configured to detect the occurrence of a collision following the replacement of the selected 3D object by the new 3D object. Furthermore, in this case, the processing unit 6 is, advantageously, configured to send a signal indicative of such a collision to the user (for example, by tinting the colliding 3D objects), and/or to implement the correction step 28 in order to correct the detected collision.

For example, if an instruction to move a given 3D object is detected, the processing unit 6 is configured to move said 3D object by following the projection of a cursor on the support surface closest to the cursor.

In this case, the processing unit 6 is, for example, configured to align the selected 3D object on said support surface, by modifying the orientation of said 3D object so that the corresponding orientation vector is normal to said support surface.

Once a 3D object and its position are convenient for the user, the latter has, for example, the possibility of locking said 3D object so that it is not affected by any subsequent user interactions with the 3D scene. In this case, preferably, the second 3D object that defines the support surface on which the locked first 3D object is aligned is also recursively locked.

In other words, in response to an instruction to lock a selected 3D object previously placed in the virtual three-dimensional reference frame, the processing unit 6 is configured to lock (that is, fix) a position, as well as an orientation (that is, the direction and the sense of the orientation vector in the virtual three-dimensional reference frame), of said selected 3D object in the virtual three-dimensional reference frame, and, preferably, its rotation about the orientation vector. Additionally, the processing unit 6 is configured to generate an instruction to lock the 3D object on which the selected 3D object is aligned.

Then, once the 3D scene is ready, the user can place the cameras he wishes and export the desired simulation.

### Operation

During the reception step 22, the processing unit 6 waits for the user to input the generation instruction.

Then, once the generation instruction has been input, the processing unit 6 selects Mᵢ 3D objects from the object bank 12 during selection step 24, for each desired 3D object type i input by the user.

Then, during the placement step 26, the processing unit 6 places each selected 3D object in the same virtual three-dimensional reference frame.

Even more precisely, the processing unit 6 aligns each selected 3D object with an active support surface existing in the virtual three-dimensional reference frame.

Additionally, after each current 3D object has been placed, the processing unit 6 updates the occupancy map.

As a result, at the end of the placement step 26, each 3D object is aligned with an active support surface of another 3D object (including the floor, if applicable) present in the virtual three-dimensional reference frame.

For example, to achieve such placement, for each current 3D object, the processing unit 26 randomly selects, during phase 261, an orientation vector from the at least one orientation vector corresponding to said 3D object.

Then, during phase 262, the processing unit 6 randomly selects an active support surface from the 3D scene.

Then, during phase 263, the processing unit 6 orients the current 3D object so that the selected orientation vector is orthogonal to the selected active support surface.

Preferably, during phase 264, the processing unit 6 applies a random rotation to the current 3D object about the selected orientation vector.

Then, during phase 265, the processing unit 6 aligns the current 3D object with the selected active support surface.

Then, during the correction step 28, the processing unit 6 detects any collisions.

In this case, for each collision detected, the processing unit 6 moves at least one 3D object affected by said collision, based on the occupancy map.

Additionally, the processing unit 6 is configured to correct the collisions detected.

For example, to achieve such a correction, the processing unit 6 repeats the processing loop shown in FIG. 4, until all collisions in the 3D scene have been processed.

More precisely, during phase 281, for at least one 3D object affected by the current collision, the processing unit 6 searches, based on the occupancy map, for an active support surface capable of receiving said 3D object without collision.

Preferably, as long as no active support surface capable of receiving said 3D object is found, during phase 282, the processing unit 6 orients the 3D object along another untested orientation vector.

Then, using the occupancy map, the processing unit 6 carries out another search, during a new phase 281, for an active support surface capable of receiving said 3D object oriented according to this new orientation vector, without causing a collision.

Then, if an active support surface capable of receiving the 3D object (without causing a collision) is found, the processing unit 6 aligns, during phase 283, the 3D object with said active support surface found. The next collision detected is then processed.

Furthermore, if no active support surface capable of receiving the 3D object is found, the processing unit 6 deletes the 3D object during phase 284. The next collision detected is then processed.

Preferably, during the modification step 30, the processing unit 6 controls the display, on the display medium 9, of the 3D scene obtained after the correction step 28.

If it detects that the user has entered an instruction to replace a 3D object in the displayed 3D scene, the processing unit 6 replaces the selected 3D object with another 3D object of the same type, preferably maintaining the same position in the virtual three-dimensional reference frame.

In this case, if the processing unit 6 detects the occurrence of a collision following the replacement of the selected 3D object by the new 3D object, the processing unit 6 implements the correction step 28 in order to correct the detected collision.

Additionally, if an instruction to move a given 3D object is detected, the processing unit 6 moves said 3D object by following the projection of a cursor on the support surface closest to the cursor. In this case, the processing unit 6 aligns the selected 3D object on said support surface.

Once a 3D object and its position are convenient for the user, the latter has, for example, the possibility of locking said 3D object so that it is not affected by any subsequent user interactions with the 3D scene. In this case, preferably, the second 3D object that defines the support surface on which the locked first 3D object is aligned is also recursively locked.

Then, once the 3D scene is ready, the user can place the cameras he wishes and export the desired simulation.

Of course, the at least one embodiment of the invention is not limited to the examples disclosed above.

1. A computer-implemented method for generating a three-dimensional scene, the computer-implemented method comprising:
based on a generation instruction comprising, for at least one predetermined 3D object type, a corresponding number of instances,
selecting, in a 3D object bank, for each 3D object type, a number of 3D objects equal to the corresponding number of instances,
the 3D object bank comprising, for each predetermined 3D object type of said at least one predetermined 3D object type, at least one corresponding 3D object, and, for each 3D object of said number of 3D objects:
at least one orientation vector indicative of a corresponding admissible orientation; and
for each orientation vector of the at least one orientation vector, a corresponding support surface, indicative of an upper surface of the each 3D object when said each 3D object is oriented along said at least one orientation vector;
for said each 3D object selected from the 3D object bank:
placing said each 3D object in a predetermined virtual three-dimensional reference frame, said each 3D object being aligned with an active support surface of the three-dimensional scene, the active support surface being a support surface orthogonal to a director vector of an altitude axis of the predetermined virtual three-dimensional reference frame, to within a predetermined angular tolerance;
updating an occupancy map of active support surfaces;
for each collision detected between 3D objects in the predetermined virtual three-dimensional reference frame, implementing a correction comprising a movement of at least one 3D object affected by said each collision based on the occupancy map.

2. The computer-implemented method according to claim 1, wherein, for each current 3D object, the placing comprises:
random selection of an orientation vector from the at least one corresponding orientation vector;
random selection of an active support surface of said active support surfaces;
orientation of the each current 3D object according to the orientation vector that is selected at random, so that the orientation vector that is selected at random is orthogonal to the active support surface that is selected at random;
alignment of the current 3D object with the active support surface that is selected at random.

3. The computer-implemented method according to claim 2, wherein the placing further comprises a random rotation of the current 3D object about the orientation vector that is selected at random.

4. The computer-implemented method according to claim 2, wherein, once the current 3D object has been aligned, an axis directed by the director vector of the altitude axis of the predetermined virtual three-dimensional reference frame and passing through a center of gravity of the current 3D object intersects the active support surface that is selected.

5. The computer-implemented method according to claim 4, wherein the center of gravity of the current 3D object is a barycenter of vertices of a mesh of said 3D object.

6. The computer-implemented method according to claim 1, wherein, for said each collision that is detected, the correction further comprises, for at least one 3D object affected by the each collision:
searching, based on the occupancy map, for an active support surface capable of receiving said each 3D object without collision;
if an active support surface capable of receiving said each 3D object without collision is found, aligning the each 3D object with said active support surface that is found.

7. The computer-implemented method according to claim 6, further comprising, as long as no active support surface capable of receiving said each 3D object without collision is found, iterative implementation of
orienting the each 3D object according to another untested orientation vector of the each 3D object;
searching, in the occupancy map, for an active support surface capable of receiving said each 3D object without collision.

8. The computer-implemented method according to claim 6, further comprising a deleting the each 3D object if no active support surface capable of receiving said each 3D object without collision is found.

9. The computer-implemented method according to claim 1, further comprising, in response to an instruction to replace a selected 3D object, previously placed in the predetermined virtual three-dimensional reference frame, replacing the selected 3D object with a new 3D object of a same 3D object type, at a same position in the predetermined virtual three-dimensional reference frame.

10. The computer-implemented method according to claim 9, further comprising, in an event of a collision being detected following the replacing of the selected 3D object by the new 3D object, implementing the correction to correct the collision that is detected.

11. The computer-implemented method according to claim 1, further comprising, in response to an instruction to lock a selected 3D object previously placed in the predetermined virtual three-dimensional reference frame, locking a position and an orientation of said selected 3D object in the predetermined virtual three-dimensional reference frame, and generating an instruction to lock the each 3D object on which the selected 3D object is aligned.

12. A computer program comprising executable instructions which, when executed by a computer, implement a computer-implemented method for generating a three-dimensional scene, the computer-implemented method comprising:
based on a generation instruction comprising, for at least one predetermined 3D object type, a corresponding number of instances,
selecting, in a 3D object bank, for each 3D object type, a number of 3D objects equal to the corresponding number of instances,
the 3D object bank comprising, for each predetermined 3D object type of said at least one predetermined 3D object type, at least one corresponding 3D object, and, for each 3D object of said number of 3D objects:
at least one orientation vector indicative of a corresponding admissible orientation; and
for each orientation vector, a corresponding support surface, indicative of an upper surface of the each 3D object when said each 3D object is oriented along said at least one orientation vector;
for said each 3D object selected from the 3D object bank:
placing said each 3D object in a predetermined virtual three-dimensional reference frame, said each 3D object being aligned with an active support surface of the three-dimensional scene, the active support surface being a support surface orthogonal to a director vector of an altitude axis of the predetermined virtual three-dimensional reference frame, to within a predetermined angular tolerance;
updating an occupancy map of active support surfaces;
for each collision detected between 3D objects in the predetermined virtual three-dimensional reference frame, implementing a correction comprising a movement of at least one 3D object affected by said each collision based on the occupancy map.

13. A computing device that generates a three-dimensional scene, the computing device comprising:
a memory and a processor,
wherein the memory is configured to store a bank of 3D objects comprising, for at least one predetermined 3D object type, at least one corresponding 3D object, and, for each 3D object of said at least one corresponding 3D object:
at least one orientation vector indicative of a corresponding admissible orientation; and
for each orientation vector of said at least one orientation vector, a corresponding support surface, indicative of an upper surface of the each 3D object when said each 3D object is oriented along said at least one orientation vector;
wherein the processor is configured to:
based on a generation instruction comprising, for at least one 3D object type of said at least one predetermined 3D object type, a corresponding number of instances,
select, from the 3D object bank, for each 3D object type of said at least one 3D object type, a number of 3D objects equal to the corresponding number of instances;
for said each 3D object selected from the 3D object bank:
placing said each 3D object in a predetermined virtual three-dimensional reference frame, said each 3D object being aligned with an active support surface of the three-dimensional scene, said active support surface being a support surface orthogonal to a director vector of an altitude axis of the predetermined virtual three-dimensional reference frame, to within a predetermined angular tolerance;
updating an occupancy map of active support surfaces;
for each collision detected between 3D objects in the predetermined virtual three-dimensional reference frame, implementing a correction comprising a movement of at least one 3D object affected by said each collision based on the occupancy map.
